(19) United States
(12) Patent Application Publication
(10) Pub. No.: US 2014/0220436 A1
(43) Pub. Date: Aug. 7, 2014

(54) METHOD FOR PRODUCING ELECTRODE ASSEMBLY, ELECTRODE ASSEMBLY, AND LITHIUM BATTERY

(71) Applicant: SEIKO EPSON CORPORATION, Tokyo (JP)

(72) Inventors: Tomofumi YOKOYAMA, Kai-shi (JP); Sukenori ICHIKAWA, Suwa-shi (JP)

(73) Assignee: SEIKO EPSON CORPORATION, Tokyo (JP)

(21) Appl. No.: 14/172,024

(22) Filed: Feb. 4, 2014

(30) Foreign Application Priority Data
Feb. 5, 2013 (JP) 2013-020420

(51) Int. Cl. H01M 4/1391; H01M 4/04; H01M 4/13

(52) U.S. Cl. CPC H01M 4/1391; H01M 4/13; H01M 4/0404; H01M 4/0471
USPC 429/211; 427/58

(57) ABSTRACT

A method for producing an electrode assembly, including a porous active material molded body, a solid electrolyte layer covering the surface of the active material molded body including the inside of each pore of the active material molded body, and a current collector in contact with the active material molded body exposed from the solid electrolyte layer, includes obtaining the active material molded body by heating a porous body formed using an active material at a temperature of 850° C. or higher and lower than the melting point of the active material, and forming the solid electrolyte layer by applying a liquid containing a constituent material of an inorganic solid electrolyte to the surface of the active material molded body including the inside of each pore of the active material molded body in a structure body including the active material molded body, and then performing a heat treatment.

### BACKGROUND

1. Technical Field

The present invention relates to a method for producing an electrode assembly, an electrode assembly, and a lithium battery.

2. Related Art

As a power source for many electronic devices such as portable information devices, a lithium battery (including a primary battery and a secondary battery) has been used. The lithium battery includes a positive electrode, a negative electrode, and an electrolyte layer which is disposed between the layers of these electrodes and mediates conduction of lithium ions.

Recently, as a lithium battery having a high energy density and safety, an all-solid-state lithium battery using a solid electrolyte as a constituent material of an electrolyte layer has been proposed (see, for example, JP-A-2009-215130, JP-A-2001-68149, JP-A-2000-311710, JP-A-2008-226666, JP-A-2006-260887, and JP-A-2011-204511).

As the lithium battery, a high-power lithium battery has been demanded, however, an all-solid-state lithium battery in the related art does not have sufficient performance, and a further improvement has been demanded.

### SUMMARY

An advantage of some aspects of the invention is to provide an electrode assembly, which is preferably used in a lithium battery and can form a high-power lithium battery. Another advantage of some aspects of the invention is to provide a method for producing an electrode assembly, which can form a high-power lithium battery. Still another advantage of some aspects of the invention is to provide a lithium battery which includes such an electrode assembly and therefore has high output power.

An aspect of the invention provides a method for producing an electrode assembly, wherein the electrode assembly includes a porous active material molded body, a solid electrolyte layer covering the surface of the active material molded body including the inside of each pore of the active material molded body, and a current collector in contact with the active material molded body exposed from the solid electrolyte layer, and the method includes obtaining the active material molded body by heating a porous body formed using an active material at a temperature of 850° C. or higher and lower than the melting point of the active material, and forming the solid electrolyte layer by applying a liquid containing a constituent material of an inorganic solid electrolyte to the surface of the active material molded body including the inside of each pore of the active material molded body in a structure body including the active material molded body, and then performing a heat treatment.

According to this method, an active material molded body to be formed has favorable conductive properties, and also a solid electrolyte layer filled in the pores of the active material molded body can be easily formed.

Further, according to this method, as compared with the case where the solid electrolyte layer is not formed in the pores of the active material molded body, a contact area between the active material molded body and the solid electrolyte layer is increased, and thus an interfacial impedance between the active material molded body and the solid electrolyte layer can be decreased. Therefore, in an electrode structure body, favorable charge transfer at an interface between the active material molded body and the solid electrolyte layer can be achieved.

Further, in the electrode assembly obtained by this method, a contact area between the active material molded body and the solid electrolyte layer (a second contact area) can be easily made larger than a contact area between the current collector and the active material molded body (a first contact area). Accordingly, when an electron transfer pathway connecting the current collector, the active material molded body, and the solid electrolyte layer is taken into account, a bottleneck of the charge transfer at an interface between the active material molded body and the solid electrolyte layer is easily eliminated, and thus, an electrode assembly capable of achieving favorable charge transfer can be formed.

Therefore, with the use of the method for producing an electrode assembly according to the aspect of the invention, an electrode assembly which can achieve favorable charge transfer and also can form a high-power lithium battery can be easily produced.

In one aspect of the invention, the production method may be configured such that the porous body is a molded body formed by compressing the active material in the form of particles.

According to this method, the active material molded body can be easily made porous.

In one aspect of the invention, the production method may be configured such that the active material has an average particle diameter of 300 nm or more and 5 μm or less.

According to this method, the active material molded body having an appropriate porosity is obtained, and therefore, a surface area of the inside of each pore of the active material molded body is increased, and also a contact area between the active material molded body and the solid electrolyte layer is easily increased. Accordingly, the capacity of a lithium battery using the electrode assembly is easily increased.

In one aspect of the invention, the production method may be configured such that the forming the solid electrolyte layer includes a first heat treatment in which the constituent material of the inorganic solid electrolyte is adhered to the surface of the porous body, and a second heat treatment in which heating is performed at a temperature not lower than the treatment temperature in the first heat treatment and 700° C. or lower.

According to this method, the solid electrolyte layer can be easily formed at a desired position.

In one aspect of the invention, the production method may be configured such that the structure body is the active material molded body, and the method includes bonding the current collector to the active material molded body after forming the solid electrolyte layer.

In one aspect of the invention, the production method may be configured such that the structure body has the active material molded body and the current collector bonded to the active material molded body, and the forming the solid electrolyte layer includes, after bonding the current collector to the active material molded body, applying the liquid to the active material molded body, and then performing a heat treatment.

According to these methods, the degree of freedom of the production steps is increased.

In one aspect of the invention, the production method may be configured such that the method includes: dividing a composite body having the solid electrolyte layer formed on the surface of the active material molded body into a plurality of segments before bonding the current collector, and in the bonding the current collector, the current collector is bonded to the active material molded body exposed on the divided surfaces of the divided composite body.

According to this method, the mass production of the electrode assembly is facilitated.

In one aspect of the invention, the production method may be configured such that the divided composite body has the plurality of divided surfaces, and in the bonding the current collector, the current collector is bonded to a portion of the plurality of divided surfaces, and a layer of an inorganic solid electrolyte is formed on the remaining portion of the plurality of divided surfaces.

According to this method, the electrode assembly in which a short circuit is reliably prevented can be easily produced.

Another aspect of the invention provides an electrode assembly including a porous active material molded body, a solid electrolyte layer covering the surface of the active material molded body including the inside of each pore of the active material molded body, and a current collector in contact with the active material molded body exposed from the solid electrolyte layer, wherein a plurality of pores of the active material molded body communicate like a mesh with one another inside the active material molded body, and a contact area between the active material molded body and the solid electrolyte layer is larger than a contact area between the current collector and the active material molded body.

According to this configuration, even if a material having electrochemical anisotropy in crystals is used as the active material, since the active material molded body has a mesh structure in such a manner that the pores communicate like a mesh with one another, an electrochemically smooth continuous surface can be formed regardless of the anisotropic electron conductivity or ionic conductivity in crystals. Accordingly, the active material molded body which secures favorable electron conduction is formed regardless of the type of active material to be used.

Further, as compared with the case where the solid electrolyte layer is not formed in the pores of the active material molded body, a contact area between the active material molded body and the solid electrolyte layer is increased, and thus an interfacial impedance between the active material molded body and the solid electrolyte layer can be decreased. Therefore, favorable charge transfer at an interface between the active material molded body and the solid electrolyte layer can be achieved.

Further, since a contact area between the active material molded body and the solid electrolyte layer (a second contact area) is larger than a contact area between the current collector and the active material molded body (a first contact area), a bottleneck of the charge transfer at an interface between the active material molded body and the solid electrolyte layer is easily eliminated, and therefore, favorable charge transfer can be achieved in the electrode assembly as a whole.

Therefore, according to the aspect of the invention, an electrode assembly which can form a high-power lithium battery can be provided.

In one aspect of the invention, the electrode assembly may be configured such that a mass loss percentage when the active material molded body and the solid electrolyte layer are heated to 400° C. for 30 minutes is 5% by mass or less.

According to this configuration, an electrode assembly can be formed such that at least 95% by mass of the active material molded body and the solid electrolyte layer is composed of an inorganic material, and thus has high stability.

In one aspect of the invention, the electrode assembly may be configured such that the active material molded body has a resistivity of 700 Ω/cm or less.

According to this configuration, when forming a lithium battery using the electrode assembly, a sufficient output power can be obtained.

In one aspect of the invention, the electrode assembly may be configured such that the solid electrolyte layer has an ionic conductivity of 1×10⁻⁵ S/cm or more.

According to this configuration, ions contained in the solid electrolyte layer at a position away from the surface of the active material molded body can also contribute to a battery reaction in the active material molded body. Accordingly, the utilization of the active material in the active material molded body is improved, and thus the capacity can be increased.

In one aspect of the invention, the electrode assembly may be configured such that the solid electrolyte layer includes a first electrolyte layer in contact with the active material molded body and a second electrolyte layer provided so as to cover the first electrolyte layer.

For example, when forming a lithium battery having an electrode assembly, depending on an inorganic solid electrolyte constituting the solid electrolyte layer, the inorganic solid electrolyte reacts with a counter electrode in contact with the solid electrolyte layer, and therefore, the function of the solid electrolyte layer may be lost. However, according to this configuration, an inorganic solid electrolyte stable for a constituent material of a counter electrode is selected as a constituent material of a second electrolyte layer, and the second electrolyte layer can be made to function as a protective layer of the first electrolyte layer, and thus, the degree of freedom of choosing the material of the first electrolyte layer is increased.

Still another aspect of the invention provides a lithium battery including the electrode assembly according to the aspect of the invention in at least one of a positive electrode and a negative electrode.

According to this configuration, since the electrode assembly according to the aspect of the invention is used, the output power can be increased.

### BRIEF DESCRIPTION OF THE DRAWINGS

The invention will be described with reference to the accompanying drawings, wherein like numbers reference like elements.

FIG. 1 is a cross-sectional side view showing a main part of an electrode assembly according to an embodiment.

FIGS. 2A and 2B are process diagrams showing a method for producing an electrode assembly according to an embodiment.

FIGS. 3A and 3B are process diagrams showing a method for producing an electrode assembly according to an embodiment.

FIGS. 4A and 4B are process diagrams showing a method for producing an electrode assembly according to an embodiment.

FIG. 5 is a cross-sectional side view of a main part showing a modification example of an electrode assembly according to an embodiment.

FIG. 6 is a cross-sectional side view of a main part showing a modification example of an electrode assembly according to an embodiment.

FIGS. 7A and 7B are process diagrams showing a modification example of a method for producing an electrode assembly according to an embodiment.

FIG. 8 is a cross-sectional side view showing a main part of a lithium battery according to an embodiment.

FIG. 9 is a cross-sectional side view showing a main part of a lithium battery according to an embodiment.

### DESCRIPTION OF EXEMPLARY EMBODIMENTS

### Electrode Assembly

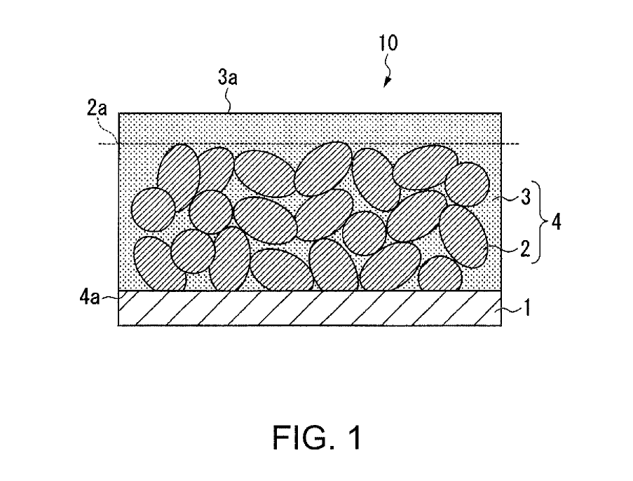

First, an electrode assembly according to this embodiment will be described. FIG. 1 is a cross-sectional side view showing a main part of an electrode assembly according to this embodiment. In all the drawings described below, in order to make the drawings easily viewable, the dimension, the ratio, etc. of each constituent member is made appropriately different from those of the actual one.

An electrode assembly 10 of this embodiment includes a current collector 1, an active material molded body 2, and a solid electrolyte layer 3. A structure in which the active material molded body 2 and the solid electrolyte layer 3 are combined is referred to as “composite body 4”. The electrode assembly 10 is used in a lithium battery as described below.

The current collector 1 is provided in contact with the active material molded body 2 exposed from the solid electrolyte layer 3 on one surface 4a of the composite body 4. As a constituent material of the current collector 1, one type of metal (a metal simple substance) selected from the group consisting of copper (Cu), magnesium (Mg), titanium (Ti), iron (Fe), cobalt (Co), nickel (Ni), zinc (Zn), aluminum (Al), germanium (Ge), indium (In), gold (Au), platinum (Pt), silver (Ag), and palladium (Pd), or an alloy containing two or more types of metal elements selected from this group can be used.

As the shape of the current collector 1, a plate, a foil, a mesh, etc. can be adopted. The surface of the current collector 1 may be smooth, or may have irregularities formed thereon.

The active material molded body 2 is a porous molded body composed of an inorganic electrode active material (active material). A plurality of pores of the active material molded body 2 communicate like a mesh with one another inside the active material molded body 2.

The constituent material of the active material molded body 2 is different between the case where the current collector 1 is used on the positive electrode side and the case where it is used on the negative electrode side in a lithium battery.

In the case where the current collector 1 is used on the positive electrode side, a material generally known as a positive electrode active material can be used as the constituent material of the active material molded body 2. Examples of such a material include lithium multiple oxides.

The term “lithium multiple oxide” as used herein refers to an oxide inevitably containing lithium, and also containing two or more types of metal ions as a whole, but free of oxoacid ions.

Examples of such a lithium multiple oxide include LiCoO₂, LiNiO₂, LiMn₂O₄, Li₂Mn₂O₃, LiFePO₄, Li₂FeP₂O₇, LiMnPO₄, LiFeBO₃, Li₃V₂(PO₄)₃, Li₂CuO₂, LiFeF₃, Li₂FeSiO₄, and Li₂MnSiO₄. Further, in this specification, solid solutions obtained by substituting some atoms in a crystal of any of these lithium multiple oxides with a transition metal, a typical metal, an alkali metal, an alkaline rare earth element, a lanthanoid, a chalcogenide, a halogen, or the like are also included in the lithium multiple oxide, and any of these solid solutions can also be used as the positive electrode active material.

In the case where the current collector 1 is used on the negative electrode side, a material generally known as a negative electrode active material can be used as the constituent material of the active material molded body 2.

Examples of the negative electrode active material include silicon-manganese alloy (Si—Mn), silicon-cobalt alloy (Si—Co), silicon-nickel alloy (Si—Ni), niobium pentoxide (Nb₂O₅), vanadium pentoxide (V₂O₅), titanium oxide (TiO₂), indium oxide (In₂O₃), zinc oxide (ZnO), tin oxide (SnO₂), nickel oxide (NiO), tin (Sn)-added indium oxide (ITO), aluminum (Al)-added zinc oxide (AZO), gallium (Ga)-added zinc oxide (GZO), antimony (Sb)-added tin oxide (ATO), fluorine (F)-added tin oxide (FTO), a carbon material, a material obtained by intercalating lithium ions into layers of a carbon material, anatase-type titanium dioxide (TiO₂), lithium multiple oxides such as Li₄Ti₅O₁₂ and Li₂Ti₃O₇, and lithium (Li) metal.

The active material molded body 2 preferably has a porosity of 10% or more and 50% or less. When the active material molded body 2 has such a porosity, a surface area of the inside of each pore of the active material molded body 2 is increased, and also a contact area between the active material molded body 2 and the solid electrolyte layer 3 is easily increased. Accordingly, the capacity of a lithium battery using the electrode assembly 10 is easily increased.

The porosity can be determined according to the following formula (I) from (1) the volume (apparent volume) of the active material molded body 2 including the pores obtained from the external dimension of the active material molded body 2, (2) the mass of the active material molded body 2, and (3) the density of the active material constituting the active material molded body 2.

Porosity(%)=[1−(mass of active material molded body)/(apparent volume)×(density of active material)]×100 (I)

The resistivity of the active material molded body 2 is preferably 700 Ω/cm or less. When the active material molded body 2 has such a resistivity, when forming a lithium battery using the electrode assembly 10, a sufficient output power can be obtained.

The resistivity can be determined by adhering a copper foil to be used as the electrode to the surface of the active material molded body, and then, performing DC polarization measurement.

The solid electrolyte layer 3 is composed of a solid electrolyte, and is provided in contact with the surface the active material molded body 2 including the inside of each pore of the active material molded body 2.

Examples of the solid electrolyte include oxides, sulfides, halides, and nitrides such as SiO₂—P₂O₅—Li₂O, SiO₂—P₂O₅—LiCl, Li₂O—LiCl—B₂O₃, Li_{3.4}V_{0.6}Si_{0.4}O₄, Li₁₄ZnGe₄O₁₆, Li_{3.6}V_{0.4}Ge_{0.6}O₄, Li_{1.3}Ti_{1.7}Al_{0.3} (PO₄)₃, Li_{2.88}PO_{3.73}N_{0.14}, LiNbO₃, Li_{0.35}La_{0.55}TiO₃, Li₇La₃zr₂O₁₂, Li₂S—SiS₂, Li₂S—SiS₂—LiI, Li₂S—SiS₂—P₂S₅, LiPON, Li₃N, LiI, LiI—CaI₂, LiI—CaO, LiAlCl₄, LiAlF₄, LiI—Al₂O₃, LiF—Al₂O₃, LiBr—Al₂O₃, Li₂O—TiO₂, La₂O₃—Li₂O—TiO₂, Li₃N, Li₃NI₂, Li₃N—LiI—LiOH, Li₃N—LiCl, Li₆NBr₃, LiSO₄, Li₄SiO₄, Li₃PO₄—Li₄SiO₄, Li₄GeO₄—Li₃VO₄, Li₄SiO₄—Li₃VO₄, Li₄GeO₄—Zn₂GeO₂, Li₄SiO₄—LiMoO₄, Li₃PO₄—Li₄SiO₄, and LiSiO₄—Li₄ZrO₄. These solid electrolytes may be crystalline or amorphous. Further, in this specification, a solid solution obtained by substituting some atoms of any of these compositions with a transition metal, a typical metal, an alkali metal, an alkaline rare earth element, a lanthanoid, a chalcogenide, a halogen, or the like can also be used as the solid electrolyte.

The ionic conductivity of the solid electrolyte layer 3 is preferably 1×10⁻⁵ S/cm or more. When the solid electrolyte layer 3 has such an ionic conductivity, ions contained in the solid electrolyte layer 3 at a position away from the surface of the active material molded body 2 reach the surface of the active material molded body 2 and can also contribute to a battery reaction in the active material molded body 2. Accordingly, the utilization of the active material in the active material molded body 2 is improved, and thus the capacity can be increased. At this time, if the ionic conductivity is less than 1×10⁻⁵ S/cm, when the electrode assembly is used in a lithium battery, only the active material in the vicinity of the surface layer of the surface facing a counter electrode contributes to the battery reaction in the active material molded body 2, and therefore, the capacity may be decreased.

The term “ionic conductivity of the solid electrolyte layer 3” as used herein refers to the “total ionic conductivity”, which is the sum of the “bulk conductivity”, which is the conductivity of the above-mentioned inorganic electrolyte itself constituting the solid electrolyte layer 3, and the “grain boundary ionic conductivity”, which is the conductivity between crystal grains when the inorganic electrolyte is crystalline.

The ionic conductivity of the solid electrolyte layer 3 can be determined as follows. A tablet-shaped body obtained by press-molding a solid electrolyte powder at 624 MPa is sintered at 700° C. in an air atmosphere for 8 hours, a platinum electrode having a diameter of 0.5 cm and a thickness of 100 nm is formed on both surfaces of the press-molded body by sputtering, and then, performing an AC impedance method. As the measurement apparatus, an impedance analyzer (model SI1260, manufactured by Solartron Co., Ltd.) is used.

In the electrode assembly 10, when the direction away from the surface of the current collector 1 in the normal direction is defined as the upper direction, the surface 3a on the upper side of the solid electrolyte layer 3 is located above the upper edge position 2a of the active material molded body 2. That is, the solid electrolyte layer 3 is formed above the upper edge position 2a of the active material molded body 2. According to this configuration, when producing a lithium battery having the electrode assembly 10 by providing an electrode on the surface 3a, the electrode provided on the surface 3a and the current collector 1 are not connected to each other through the active material molded body 2, and therefore, a short circuit can be prevented.

The electrode assembly 10 of this embodiment is formed without using an organic material such as a binder for binding the active materials to each other or a conductive additive for securing the conductive properties of the active material molded body 2 when forming the active material molded body 2, and is composed of almost only an inorganic material. Specifically, in the electrode assembly 10 of this embodiment, a mass loss percentage when the composite body 4 (the active material molded body 2 and the solid electrolyte layer 3) is heated to 400° C. for 30 minutes is 5% by mass or less. The mass loss percentage is preferably 3% by mass or less, more preferably 1% by mass or less, and particularly preferably the mass loss is not observed or is the limit of error. That is the mass loss percentage when the composite body 4 is heated to 400° C. for 30 minutes is preferably 0% by mass or more.

Since the composite body 4 shows a mass loss percentage as described above, in the composite body 4, a material which is evaporated under predetermined heating conditions such as a solvent or adsorbed water, or an organic material which is vaporized by burning or oxidation under predetermined heating conditions is contained in an amount of only 5% by mass or less with respect to the total mass of the structure.

The mass loss percentage of the composite body 4 can be determined as follows. By using a thermogravimetric/differential thermal analyzer (TG-DTA), the composite body 4 is heated under predetermined heating conditions, and the mass of the composite body 4 after heating under the predetermined heating conditions is measured, and the mass loss percentage is calculated from the ratio between the mass before heating and the mass after heating.

In the electrode assembly 10 of this embodiment, a plurality of pores communicate like a mesh with one another inside the active material molded body 2, and also in the solid portion of the active material molded body 2, a mesh structure is formed. For example, LiCoO₂ which is a positive electrode active material is known to have anisotropic electron conductivity in crystals, however, when the active material molded body is tried to be formed using LiCoO₂ as a constituent material, in the case where the active material molded body has a configuration such that pores are formed by a mechanical process so as to extend in a specific direction, electron conduction may possibly hardly take place therein depending on the direction on which crystals show electron conductivity. However, if the pores communicate like a mesh with one another as in the case of the active material molded body 2 and the solid portion of the active material molded body 2 has a mesh structure, an electrochemically smooth continuous surface can be formed regardless of the anisotropic electron conductivity or ionic conductivity in crystals. Accordingly, favorable electron conduction can be secured regardless of the type of active material to be used.

Further, in the electrode assembly 10 of this embodiment, since the composite body 4 has a configuration as described above, the addition amount of a binder or a conductive additive contained in the composite body 4 is reduced, and thus, as compared with the case where a binder or a conductive additive is used, the capacity density per unit volume of the electrode assembly 10 is improved.

Further, in the electrode assembly 10 of this embodiment, the solid electrolyte layer 3 is in contact also with the surface of the inside of each pore of the porous active material molded body 2. Therefore, as compared with the case where the active material molded body 2 is not porous or the case where the solid electrolyte layer 3 is not formed in the pores, a contact area between the active material molded body 2 and the solid electrolyte layer 3 is increased, and thus, an interfacial impedance can be decreased. Accordingly, favorable charge transfer at an interface between the active material molded body 2 and the solid electrolyte layer 3 can be achieved.

Further, in the electrode assembly 10 of this embodiment, while the current collector 1 is in contact with the active material molded body 2 exposed on one surface of the composite body 4, the solid electrolyte layer 3 penetrates into the pores of the porous active material molded body 2 and is in contact with the surface of the active material molded body 2 including the inside of each pore and excluding the surface in contact with the current collector 1. It is apparent that in the electrode assembly 10 having such a configuration, a contact area between the active material molded body 2 and the solid electrolyte layer 3 (a second contact area) is larger than a contact area between the current collector 1 and the active material molded body 2 (a first contact area).

If the electrode assembly has a configuration such that the first contact area and the second contact area are the same, since charge transfer is easier at an interface between the current collector 1 and the active material molded body 2 than at an interface between the active material molded body 2 and the solid electrolyte layer 3, the interface between the active material molded body 2 and the solid electrolyte layer 3 becomes a bottleneck of the charge transfer. Due to this, favorable charge transfer is inhibited in the electrode composite as a whole.

However, in the electrode assembly 10 of this embodiment, the second contact area is larger than the first contact area, and therefore, the above-mentioned bottleneck is easily eliminated, and thus, favorable charge transfer can be achieved in the electrode assembly as a whole.

Accordingly, the electrode assembly 10 of this embodiment can improve the capacity of a lithium battery using the electrode assembly 10, and also the output power can be increased.

### Method for Producing Electrode Assembly

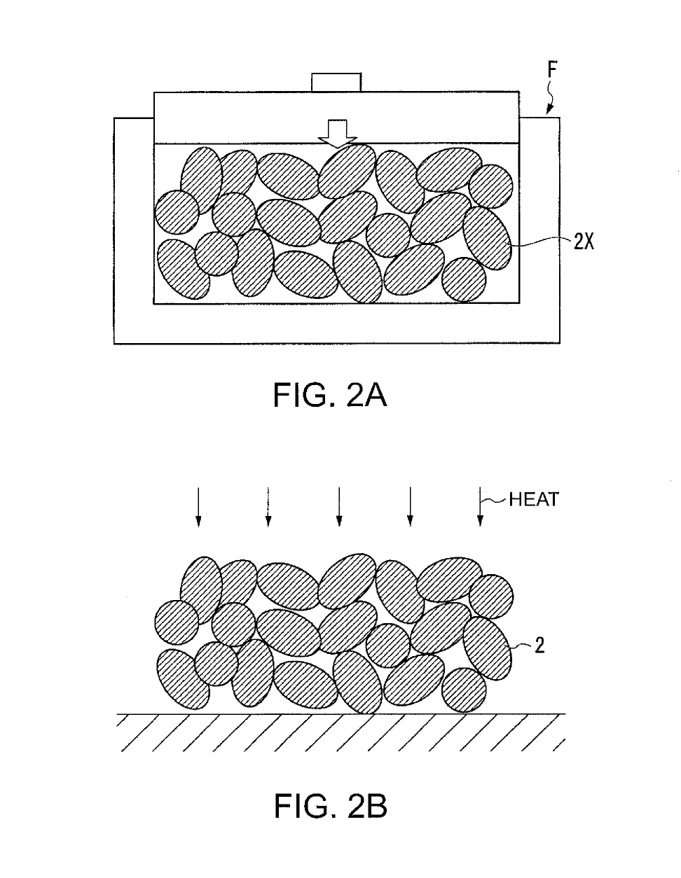

Next, with reference to FIGS. 2A to 4B, a method for producing the electrode assembly 10 according to this embodiment will be described. FIGS. 2A to 4B are process diagrams showing the method for producing the electrode assembly 10 according to this embodiment.

First, as shown in FIGS. 2A and 2B, an active material in the form of particles (hereinafter referred to as “active material particles 2X”) is molded by compression using a mold F (FIG. 2A), followed by a heat treatment, whereby an active material molded body 2 is obtained (FIG. 2B).

By performing a heat treatment, grain boundary growth in the active material particles 2X and sintering between the active material particles 2X are allowed to proceed so that the retention of the shape of the obtained active material molded body 2 is facilitated, and thus, the addition amount of a binder in the active material molded body 2 can be decreased. Further, a bond is formed between the active material particles 2X by sintering so as to form an electron transfer pathway between the active material particles 2X, and therefore, the addition amount of a conductive additive can also be decreased.

The obtained active material molded body 2 is configured such that a plurality of pores of the active material molded body 2 communicate like a mesh with one another inside the active material molded body 2.

In this step, as the active material particles 2X, a powder of the above-mentioned positive electrode active material or negative electrode active material can be used. The average particle diameter of the active material particles 2X is preferably 300 nm or more and 5 μm or less. When an active material having such an average particle diameter is used, the porosity of the obtained active material molded body 2 falls within the range of 10% to 40%. As a result, a surface area of the inside of each pore of the active material molded body 2 is increased, and also a contact area between the active material molded body 2 and the solid electrolyte layer 3 is easily increased. Accordingly, the capacity of a lithium battery using the electrode assembly 10 is easily increased.

The average particle diameter of the active material particles 2X can be determined by dispersing the active material particles 2X in n-octanol at a concentration ranging from 0.1 to 10% by mass, and then, measuring the median diameter using a light scattering particle size distribution analyzer (Nanotrac UPA-EX250, manufactured by Nikkiso Co., Ltd.).

If the average particle diameter of the active material particles 2X is less than 300 nm, the pores of the formed active material molded body tend to be small such that the radius of each pore is several tens of nanometers, and it becomes difficult to allow a liquid containing a precursor of the inorganic solid electrolyte to penetrate into each pore in the below-mentioned step. As a result, it becomes difficult to form the solid electrolyte layer 3 which is in contact with the surface of the inside of each pore.

If the average particle diameter of the active material particles 2X exceeds 5 μm, a specific surface area which is a surface area per unit mass of the formed active material molded body is decreased, and thus, a contact area between the active material molded body 2 and the solid electrolyte layer 3 is decreased. Therefore, when forming a lithium battery using the obtained electrode assembly 10, a sufficient output power cannot be obtained. Further, the ion diffusion distance from the inside of the active material to the solid electrolyte layer 3 is increased, and therefore, it becomes difficult for the active material around the center of the active material particle 2X to contribute to the function of a battery.

The average particle diameter of the active material particles 2X is more preferably 450 nm or more and 3 μm or less, further more preferably 500 nm or more and 1 μm or less.

When press-molding the powder, a binder composed of an organic polymer compound such as polyvinylidene fluoride (PVdF) or polyvinyl alcohol (PVA) may be added to the active material particles 2X. Such a binder is burned or oxidized in the heat treatment in this step, and the amount thereof is reduced.

The heat treatment in this step is performed at a treatment temperature of 850° C. or higher and lower than the melting point of the active material to be used. By this heat treatment, the active material particles 2X are sintered with one another, whereby an integrated molded body is formed. By performing the heat treatment at a temperature in such a range, an active material molded body 2 having a resistivity of 700 Ω/cm or less can be obtained without adding a conductive additive. Accordingly, when forming a lithium battery using the electrode assembly 10, a sufficient output power can be obtained.

At this time, if the treatment temperature is lower than 850° C., not only sintering does not sufficiently proceed, but also the electron conductivity itself in the crystals of the active material is decreased, and therefore, when forming a lithium battery using the obtained electrode assembly 10, a desired output power cannot be obtained.

Further, if the treatment temperature exceeds the melting point of the active material, lithium ions are excessively volatilized from the inside of the crystals of the active material, and therefore, the electron conductivity is decreased, and thus, the capacity of the obtained electrode assembly 10 is also decreased.

Accordingly, in order to obtain appropriate output power and capacity, the treatment temperature is preferably 850° C. or higher and lower than the melting point of the active material, more preferably 875° C. or higher and 1000° C. or lower, and most preferably 900° C. or higher and 920° C. or lower.

Further, the heat treatment in this step is performed for preferably 5 minutes or more and 36 hours or less, more preferably 4 hours or more and 14 hours or less.

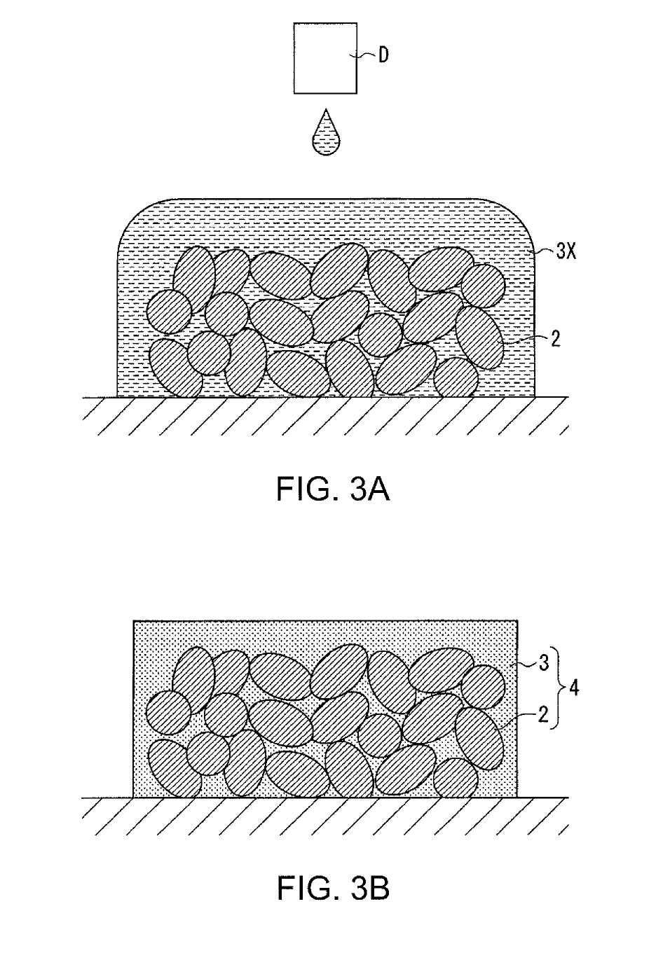

Subsequently, as shown in FIGS. 3A and 3B, a liquid 3X containing a precursor of the inorganic solid electrolyte is applied to the surface of the active material molded body 2 including the inside of each pore of the active material molded body (FIG. 3A), followed by firing to convert the precursor to the inorganic solid electrolyte, whereby the solid electrolyte layer 3 is formed (FIG. 3B).

The liquid 3X may contain a solvent which can dissolve the precursor in addition to the precursor. In the case where the liquid 3X contains a solvent, after applying the liquid 3X, the solvent may be appropriately removed before firing. As the method for removing the solvent, a generally known method such as heating, pressure reduction, or air-blowing, or a method in which two or more such generally known methods are combined can be adopted.

Since the solid electrolyte layer 3 is formed by applying the liquid 3X having fluidity, it becomes possible to favorably form a solid electrolyte also on the surface of the inside of each fine pore of the active material molded body 2. Accordingly, a contact area between the active material molded body 2 and the solid electrolyte layer 3 is easily increased so that a current density at an interface between the active material molded body 2 and the solid electrolyte layer 3 is decreased, and thus, it becomes easy to obtain a high output power.

The liquid 3X can be applied by any of various methods as long as the method can allow the liquid 3X to penetrate into the pores of the active material molded body 2. For example, a method in which the liquid 3X is added dropwise to a place where the active material molded body 2 is placed, a method in which the active material molded body 2 is immersed in a place where the liquid 3X is pooled, or a method in which an edge portion of the active material molded body 2 is brought into contact with a place where the liquid 3X is pooled so that the inside of each pore is impregnated with the liquid 3X by utilizing a capillary phenomenon may be adopted. In FIG. 3A, a method in which the liquid 3X is added dropwise using a dispenser D is shown.

Examples of the precursor include the following precursors (A), (B), and (C): (A) a composition including a salt which contains a metal atom to be contained in the inorganic solid electrolyte at a ratio according to the compositional formula of the inorganic solid electrolyte, and is converted to the inorganic solid electrolyte by oxidation; (B) a composition including a metal alkoxide containing a metal atom to be contained in the inorganic solid electrolyte at a ratio according to the compositional formula of the inorganic solid electrolyte; and (C) a dispersion liquid in which the inorganic solid electrolyte in the form of fine particles or a sol in the form of fine particles containing a metal atom to be contained in the inorganic solid electrolyte at a ratio according to the compositional formula of the inorganic solid electrolyte is dispersed in a solvent, or (A), or (B). The precursor (B) is a precursor when the inorganic solid electrolyte is formed using a so-called sol-gel method.

The precursor is fired in an air atmosphere at a temperature lower than the temperature in the heat treatment for obtaining the active material molded body 2 described above. The firing may be performed at a temperature of 300° C. or higher and 700° C. or lower. By the firing, the inorganic solid electrolyte is produced from the precursor, thereby forming the solid electrolyte layer 3.

By performing firing at a temperature in such a range, a solid phase reaction occurs at an interface between the active material molded body 2 and the solid electrolyte layer 3 due to mutual diffusion of elements constituting the respective members, and the production of electrochemically inactive side products can be suppressed. Further, the crystallinity of the inorganic solid electrolyte is improved, and thus, the ionic conductivity of the solid electrolyte layer 3 can be improved. In addition, at the interface between the active material molded body 2 and the solid electrolyte layer 3, a sintered portion is generated, and thus, charge transfer at the interface is facilitated.

Accordingly, the capacity and the output power of a lithium battery using the electrode assembly 10 are improved.

The firing may be performed by performing a heat treatment once, or may be performed by dividing the heat treatment into a first heat treatment in which the precursor is adhered to the surface of the porous body and a second heat treatment in which heating is performed at a temperature not lower than the treatment temperature in the first heat treatment and 700° C. or lower. By performing the firing by such a stepwise heat treatment, the solid electrolyte layer 3 can be easily formed at a desired position.

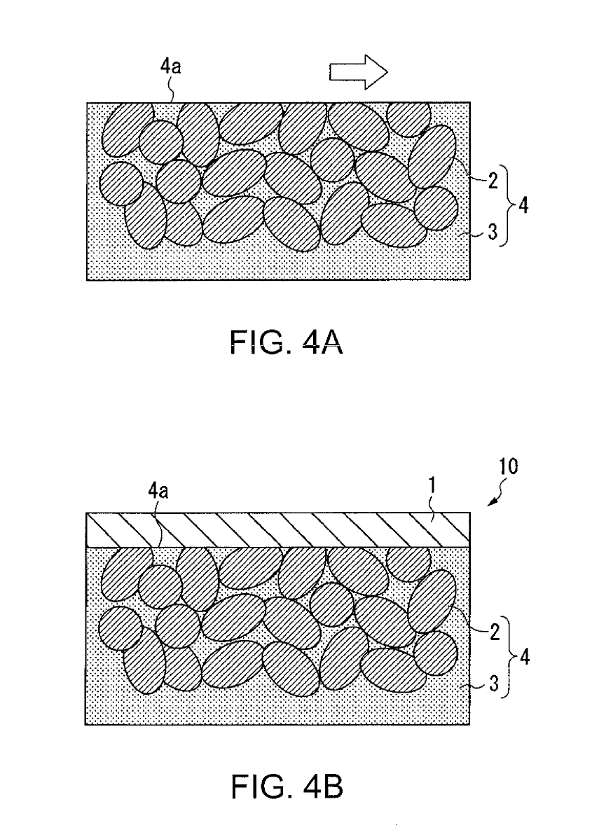

Subsequently, as shown in FIGS. 4A and 4B, the current collector 1 is bonded to the active material molded body 2 exposed on one surface of the composite body 4 including the active material molded body 2 and the solid electrolyte layer 3, whereby the electrode assembly 10 is produced. In this embodiment, after polishing the surface 4a of the composite body 4 (FIG. 4A), the current collector 1 is formed on the surface 4a of the composite body 4 (FIG. 4B).

By polishing the surface 4a of the composite body 4 before bonding the current collector 1 thereto, the active material molded body 2 is reliably exposed on the surface 4a of the composite body 4, and thus, the current collector 1 and the active material molded body 2 can be reliably bonded to each other.

Incidentally, the active material molded body 2 may be sometimes exposed on the surface to be in contact with the mounting surface of the composite body 4 when forming the composite body 4. In this case, even if the composite body 4 is not polished, the current collector 1 and the active material molded body 2 can be bonded to each other.

The bonding of the current collector 1 may be performed by bonding the current collector formed as a separate body to the surface 4a of the composite body 4, or may be performed by depositing a constituent material of the current collector 1 described above on the surface 4a of the composite body 4, thereby forming the current collector 1 on the surface 4a of the composite body 4. As the deposition method, a generally known physical vapor deposition method (PVD) or chemical vapor deposition method (CVD) can be adopted.

In the production method according to this embodiment, the objective electrode assembly 10 is produced in this manner.

According to the electrode assembly configured as described above, it can be preferably used in a lithium battery, and a high-power lithium battery can be formed.

According to the method for producing an electrode assembly configured as described above, an electrode assembly capable of forming a high-power lithium battery can be easily produced.

In this embodiment, the active material molded body 2 is formed by press-molding a powder, however, the method is not limited thereto. For example, it is also possible to obtain a porous active material molded body by mixing, as a pore template, a polymer or a carbon powder in the form of particles as a pore-forming material in a raw material when preparing an active material molded body by a generally known sol-gel method, thereby forming an active material while decomposing and removing the pore-forming material during heating.

Further, in this embodiment, after preparing the composite body 4 by forming the solid electrolyte layer 3 on the active material molded body 2, the current collector 1 is bonded to the active material molded body 2, but the method is not limited thereto. For example, after bonding the foil-shaped current collector 1 to the active material molded body 2, the solid electrolyte layer 3 may be formed on the active material molded body 2. Since the electrode assembly can be produced even if the steps are performed in such an order, the degree of freedom of the production steps is increased. Further, the active material molded body 2 and the current collector 1 can be reliably bonded to each other.

### Modification Example 1

In this embodiment, the solid electrolyte layer 3 is composed of a single layer, however, it does not matter if a solid electrolyte layer is composed of a plurality of layers.

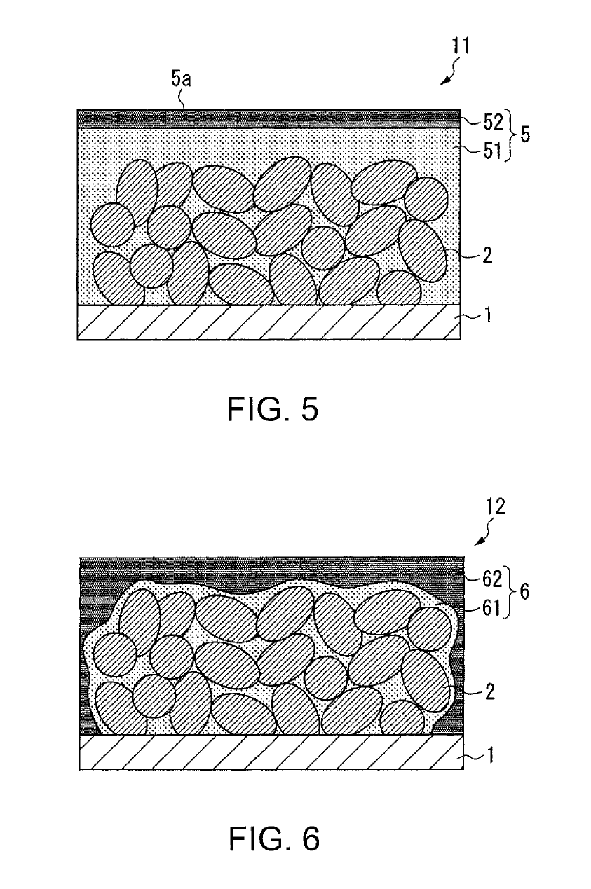

FIGS. 5 and 6 are cross-sectional side views of a main part showing a modification example of an electrode assembly and are views corresponding to FIG. 1.

An electrode assembly 11 shown in FIG. 5 includes a current collector 1, an active material molded body 2, a first electrolyte layer 51 which is composed of a solid electrolyte and is provided in contact with the surface of the active material molded body 2 including the inside of each pore of the active material molded body 2, and a second electrolyte layer 52 which is provided thinly in contact with the surface of the first electrolyte layer 51. The first electrolyte layer 51 and the second electrolyte layer 52 constitute a solid electrolyte layer 5 as a whole. The solid electrolyte layer 5 is configured such that the volume of the first electrolyte layer 51 is larger than that of the second electrolyte layer 52.

The solid electrolyte layer 5 in which a plurality of layers are laminated can be produced by performing the method for forming the solid electrolyte layer 3 described above per layer. Alternatively, after a liquid for forming the first electrolyte layer 51 is applied, a precursor is adhered by performing a first heat treatment, and then, a liquid for forming the second electrolyte layer 52 is applied, and thereafter, a precursor is adhered by performing the first heat treatment, and then, the adhered precursors in the plurality of layers are subjected to a second heat treatment, whereby the solid electrolyte layer 5 in which a plurality of layers are laminated may be formed.

As the constituent materials of the first electrolyte layer 51 and the second electrolyte layer 52, the same constituent materials as those of the solid electrolyte layer 3 described above can be adopted. The constituent materials of the first electrolyte layer 51 and the second electrolyte layer 52 may be the same as or different from each other. By providing the second electrolyte layer 52, when a lithium battery having the electrode assembly 11 is produced by providing an electrode on the surface 5a of the solid electrolyte layer 5, a short circuit caused by connecting the electrode provided on the surface 5a to the current collector 1 through the active material molded body 2 can be prevented.

Further, when a lithium battery including the electrode assembly 11 is produced, if an alkali metal is selected as the material of an electrode to be formed, depending on an inorganic solid electrolyte constituting the solid electrolyte layer, due to the reducing activity of the alkali metal, the inorganic solid electrolyte constituting the solid electrolyte layer is reduced so that the function of the solid electrolyte layer may be lost. In such a case, when an inorganic solid electrolyte which is stable for the alkali metal is selected as the constituent material of the second electrolyte layer 52, the second electrolyte layer 52 functions as a protective layer for the first electrolyte layer 51, and thus, the degree of freedom of choosing the material of the first electrolyte layer 51 is increased.

In the case where the second electrolyte layer is used as a protective layer for the first electrolyte layer as in the case of the electrode assembly 11, if the electrode assembly has a configuration such that the second electrolyte layer is interposed between the first electrolyte layer and the electrode provided on the surface of the solid electrolyte layer, the volume ratio between the first electrolyte layer and the second electrolyte layer can be appropriately changed.

For example, as an electrode assembly 12 shown in FIG. 6, the electrode assembly may have a configuration such that a solid electrolyte layer 6 includes a first electrolyte layer 61, which is formed thinly in contact with the surface of the active material molded body 2 including the inside of each pore of the active material molded body 2, and also includes a second electrolyte layer 62 which is formed thickly and is provided in contact with the surface of the first electrolyte layer 61, and the volume of the second electrolyte layer 62 is made larger than that of the first electrolyte layer 61.

### Modification Example 2

In this embodiment, after forming the composite body 4 in which the active material molded body 2 and the solid electrolyte layer 3 are combined, the current collector 1 is formed on the formed composite body 4, however, the invention is not limited thereto.

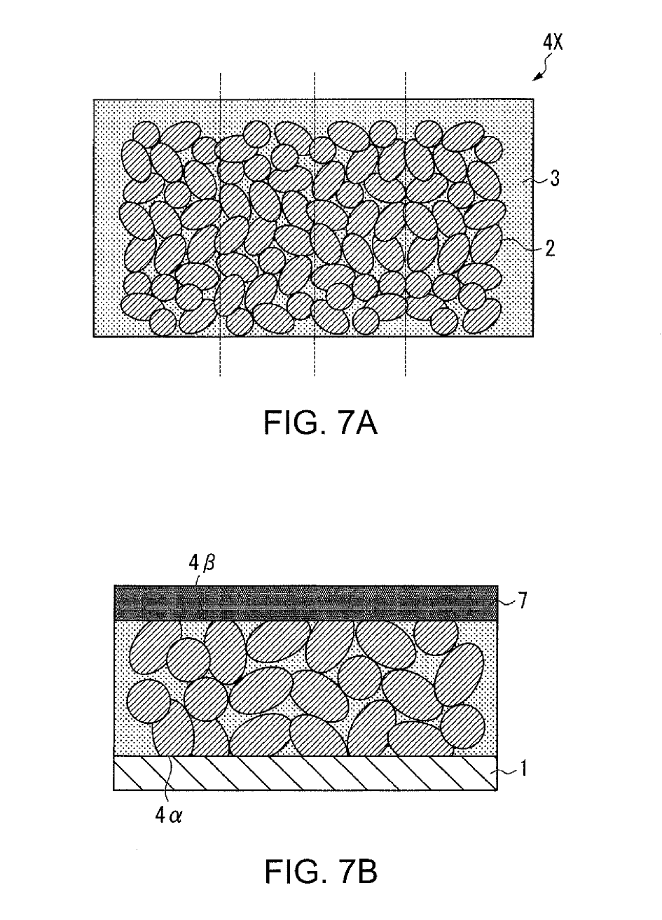

FIGS. 7A and 7B are process diagrams showing a part of a modification example of a method for producing an electrode assembly.

In the method for producing an electrode assembly shown in FIGS. 7A and 7B, first, as shown in FIG. 7A, a bulk body 4X of a structure body in which an active material molded body 2 and a solid electrolyte layer 3 are combined is formed, and then, the bulk body 4X is divided into a plurality of segments in accordance with the size of the objective electrode assembly. In FIG. 7A, a division position is indicated by a broken line, and the drawing shows that the bulk body 4X is divided by cleaving in the direction intersecting the longitudinal direction of the bulk body 4X at a plurality of positions in the longitudinal direction of the bulk body 4X so that the plurality of divided surfaces face each other.

Subsequently, as shown in FIG. 73, in a composite body 4Y obtained by cleaving the bulk body 4X, a current collector 1 is formed on one divided surface 4a thereof. Further, on the other divided surface 43, an inorganic solid electrolyte layer (a solid electrolyte layer 7) covering the active material molded body 2 exposed on the divided surface 4p is formed. The current collector 1 and the solid electrolyte layer 7 can be formed by the above-mentioned method.

According to the method for producing an electrode assembly having a configuration as described above, by forming the bulk body 4x in advance, the mass production of the electrode assembly capable of forming a high-power lithium battery is facilitated.

### Lithium Battery

Next, a lithium battery according to this embodiment will be described.

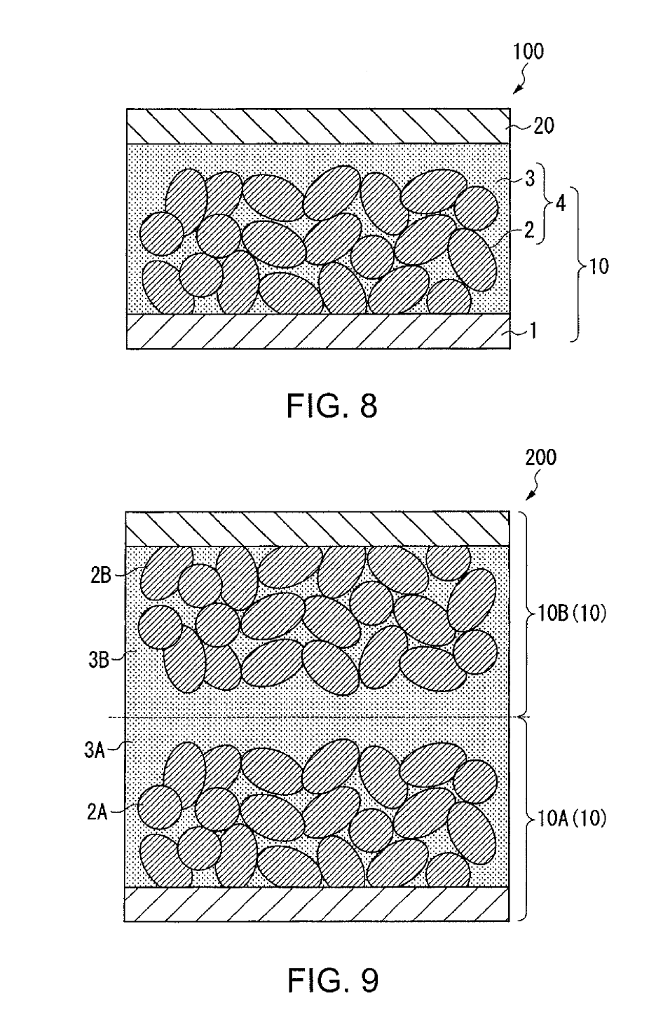

FIGS. 8 and 9 are cross-sectional side views showing a main part of a lithium battery according to this embodiment, and are views in a visual field corresponding to FIG. 1.

A lithium battery 100 shown in FIG. 8 includes the above-mentioned electrode assembly 10 and an electrode 20 provided on the surface 3a of the solid electrolyte layer 3 in the electrode assembly 10. In the case where the constituent material of the active material molded body 2 is a positive electrode active material, the current collector 1 serves as a current collector on the positive electrode side, and the electrode 20 serves as a negative electrode. In the case where the constituent material of the active material molded body is a negative electrode active material, the current collector 1 serves as a current collector on the negative electrode side, and the electrode 20 serves as a positive electrode.

For example, in the case where the constituent material of the active material molded body 2 is a positive electrode active material, as the constituent material of the current collector 1, aluminum can be selected, and as the constituent material of the electrode 20 which functions as a negative electrode, lithium can be selected.

According to the lithium battery 100 configured as described above, since the lithium battery uses the above-mentioned electrode assembly 10, the output power and the capacity can be increased.

In a lithium battery 200 shown in FIG. 9, the above-mentioned electrode assembly 10 is provided on the positive electrode side and the negative electrode side. That is, the lithium battery 200 is provided with an electrode assembly 10A on the positive electrode side and an electrode assembly 10B on the negative electrode side, and is configured such that the solid electrolyte layers of the electrode assembly 10A and the electrode assembly 10B are allowed to abut on each other and integrated with each other.

In the electrode assembly 10A, as the constituent material of an active material molded body 2A, a positive electrode active material is used, and in the electrode assembly 10B, as the constituent material of an active material molded body 2B, a negative electrode active material is used.

A solid electrolyte layer 3A in the electrode assembly 10A and a solid electrolyte layer 3B in the electrode assembly 10B may be composed of the same material or different materials.

Also the lithium battery 200 configured as described above can have high output power and high capacity because it uses the above-mentioned electrode assembly 10.

Hereinabove, preferred embodiments according to the invention are described with reference to the accompanying drawings, however, it is needless to say that the invention is not limited to the embodiments. The shapes of the respective constituent members, combinations thereof, etc. described in the above-mentioned embodiments are merely examples and various modifications can be made based on design requirements, etc. without departing from the gist of the invention.

### EXAMPLES

Hereinafter, the invention will be described with reference to Examples, however, the invention is not limited to these Examples.

### Example 1

### 1. Formation of Active Material Molded Body

LiCoO₂ (manufactured by Sigma-Aldrich Co., Ltd.) particles were classified in n-butanol using a wet centrifugal classifier (model LC-1000, manufactured by Krettek Verfahrenstechnik GmbH), whereby a powder having an average particle diameter of 1 μm was obtained. In the obtained LiCoO₂ powder, polyacrylic acid as a binder was mixed at 3.5% by mass, and the resulting mixture was kneaded and then molded into a disk having a diameter of 1 cm and a thickness of 0.3 mm at a pressure of 624 MPa. The obtained press-molded body was sintered by heating to 900° C. in an air atmosphere for 8 hours, and then, gradually cooled, whereby an active material molded body composed of LiCoO₂ which is a positive electrode active material was obtained.

The obtained active material molded body was a porous material having a porosity of 37%, and had a resistivity of 650 Ω/cm when applying a DC current.

### 2. Formation of Solid Electrolyte Layer

Lithium nitrate, lanthanum nitrate, and citric acid were dissolved in an aqueous solution of a peroxotitanate-citrate complex obtained by dissolving a titanium powder in a hydrogen peroxide solution and adding citric acid thereto, whereby a first liquid containing a precursor of a solid electrolyte was prepared. The thus prepared first liquid was added dropwise to the active material molded body obtained above, and the active material molded body was left to stand until the liquid was sufficiently impregnated into the body. Thereafter, the body was heated to 500° C. in an air atmosphere for 10 minutes, whereby a first electrolyte layer composed of Li_{0.35}La_{0.55}TiO₃ was formed.

Subsequently, zirconium acetate, lithium acetate, lanthanum acetate, and citric acid were dissolved in pure water, whereby a second liquid containing a precursor of a solid electrolyte was prepared. The thus prepared second liquid was added dropwise to the active material molded body having the first electrolyte layer formed thereon obtained above, and the body was dried by heating to 70° C. on a hot plate, and then heated to 500° C. in an air atmosphere for 10 minutes, whereby a second electrolyte layer composed of Li₇La₃Zr₂O₁₂ was formed.

Subsequently, the active material molded body having the first electrolyte layer and the second electrolyte layer formed thereon was fired by heating to 680° C. in an air atmosphere for 14 hours to form a solid electrolyte layer, whereby a composite body 1 which is the active material molded body having the solid electrolyte layer formed thereon was formed.

### 3. Formation of Battery Cell

In the composite body 1, one surface of the disk was polished using an abrasive (a lapping film sheet #15000, abrasive grain size: 0.3 μm, manufactured by 3M Corporation), and on the polished surface, a Pt film having a thickness of 100 nm was formed by sputtering in an Ar atmosphere, whereby a current collector on the positive electrode side was formed.

Subsequently, on the surface of the composite body 1 opposite to the surface on which the Pt film was formed, a lithium metal foil having a thickness of 40 μm punched into a circle having a diameter of 0.5 cm and a copper foil having a thickness of 100 μm punched into a circle having a diameter of 0.8 cm were laminated in this order from the side of the composite body 1, and the layers were press-bonded to each other at a pressure of 255 kPa, whereby a negative electrode was formed. In this manner, a laminate cell of this Example was formed.

The thus obtained laminate cell as a secondary battery cell was connected to a multi-channel charge/discharge tester (HJ1001SD8, manufactured by Hokuto Denko Corporation) and the charge/discharge behavior thereof was evaluated under the driving conditions that the current density was set to 0.1 mA/cm and the upper limit charge voltage was set to 4.2 V in a constant current-constant voltage mode and the lower limit discharge voltage was set to 3.0 V in a constant current mode. As a result, the cell showed normal charge/discharge behavior.

### Comparative Example 1

Lithium nitrate, lanthanum nitrate, and citric acid were dissolved in an aqueous solution of a peroxotitanate-citrate complex obtained by dissolving a titanium powder in a hydrogen peroxide solution and adding citric acid thereto, whereby a liquid containing a precursor of a solid electrolyte was prepared. The thus prepared liquid was fired at 700° C., whereby Li_{0.35}La_{0.55}TiO₃ was synthesized.

The thus obtained Li_{0.35}La_{0.55}TiO₃ was ground in an agate mortar, whereby a powder having a median particle diameter of about 500 nm was obtained. The median particle diameter was determined using a dynamic light scattering particle size distribution analyzer (Nanotrac Wave-EX250, manufactured by Nikkiso Co., Ltd.) after dispersing the powder obtained by grinding Li_{0.35}La_{0.55}TiO₃ in n-butanol.

This powder was added and mixed in an amount of 10% by mass with respect to the amount of the LiCoO₂ powder having an average particle diameter of 1 μm, which is a positive electrode active material and was prepared by the method in the Example, and the resulting mixture was molded into a disk at a pressure of 624 MPa.

The thus obtained disk was sintered at 700° C. for 14 hours, whereby a composite body 2 in which the solid electrolyte powder and the positive electrode active material were sintered was formed. The resistivity of the composite body 2 when applying a direct current was measured. Also, in the same manner as in Example 1 except that the composite body 2 was used in place of the composite body 1, a laminate cell was formed, and the laminate cell was connected to a multi-channel charge/discharge tester (HJ1001SD8, manufactured by Hokuto Denko Corporation) and the charge/discharge behavior of the laminate cell was evaluated under the driving conditions that the current density was set to 0.5 mA/cm and the upper limit charge voltage was set to 4.2 V in a constant current-constant voltage mode and the lower limit discharge voltage was set to 3.0 V in a constant current mode.

As a result of the evaluation, the composite body 2 had a direct current electrical resistivity of several hundreds of mega-ohm centimeters, which was extremely high. Further, the obtained laminate cell could not be driven as a normal secondary battery cell under the driving conditions of the above-mentioned charge/discharge test.

Based on these results, the usefulness of the invention was confirmed.

The entire disclosure of Japanese Patent Application No. 2013-020420, filed Feb. 5, 2013 is expressly incorporated reference herein.

What is claimed is:

1. A method for producing an electrode assembly, wherein
the electrode assembly includes a porous active material molded body, a solid electrolyte layer covering the surface of the active material molded body including the inside of each pore of the active material molded body, and a current collector in contact with the active material molded body exposed from the solid electrolyte layer, and
the method comprises:
obtaining the active material molded body by heating a porous body formed using an active material at a temperature of 850° C. or higher and lower than the melting point of the active material; and
forming the solid electrolyte layer by applying a liquid containing a constituent material of an inorganic solid electrolyte to the surface of the active material molded body including the inside of each pore of the active material molded body in a structure body including the active material molded body, and then performing a heat treatment.

2. The method for producing an electrode assembly according to claim 1, wherein the porous body is a molded body formed by compressing the active material in the form of particles.

3. The method for producing an electrode assembly according to claim 2, wherein the active material has an average particle diameter of 300 nm or more and 5 μm or less.

4. The method for producing an electrode assembly according to claim 1, wherein the forming the solid electrolyte layer includes:
a first heat treatment in which the constituent material of the inorganic solid electrolyte is adhered to the surface of the porous body; and
a second heat treatment in which heating is performed at a temperature not lower than the treatment temperature in the first heat treatment and 700° C. or lower.

5. The method for producing an electrode assembly according to claim 1, wherein
the structure body is the active material molded body, and
the method includes bonding the current collector to the active material molded body after forming the solid electrolyte layer.

6. The method for producing an electrode assembly according to claim 5, wherein
the method includes dividing a composite body having the solid electrolyte layer formed on the surface of the active material molded body into a plurality of segments before bonding the current collector, and
in the bonding the current collector, the current collector is bonded to the active material molded body exposed on the divided surfaces of the divided composite body.

7. The method for producing an electrode assembly according to claim 6, wherein
the divided composite body has the plurality of divided surfaces, and
in the bonding the current collector, the current collector is bonded to a portion of the plurality of divided surfaces, and a layer of an inorganic solid electrolyte is formed on the remaining portion of the plurality of divided surfaces.

8. The method for producing an electrode assembly according to claim 1, wherein
the structure body has the active material molded body and the current collector bonded to the active material molded body, and
the forming the solid electrolyte layer includes, after bonding the current collector to the active material molded body, applying the liquid to the active material molded body, and then performing a heat treatment.

9. An electrode assembly, comprising:
a porous active material molded body;
a solid electrolyte layer covering the surface of the active material molded body including the inside of each pore of the active material molded body; and
a current collector in contact with the active material molded body exposed from the solid electrolyte layer, wherein
a plurality of pores of the active material molded body communicate like a mesh with one another inside the active material molded body, and
a contact area between the active material molded body and the solid electrolyte layer is larger than a contact area between the current collector and the active material molded body.

10. The electrode assembly according to claim 9, wherein a mass loss percentage when the active material molded body and the solid electrolyte layer are heated to 400° C. for 30 minutes is 5% by mass or less.

11. The electrode assembly according to claim 9, wherein the active material molded body has a resistivity of 700 Ω/cm or less.

12. The electrode assembly according to claim 9, wherein the solid electrolyte layer has an ionic conductivity of 1×10⁻⁵ S/cm or more.

13. The electrode assembly according to claim 9, wherein the solid electrolyte layer includes a first electrolyte layer in contact with the active material molded body and a second electrolyte layer provided so as to cover the first electrolyte layer.

14. A lithium battery, comprising the electrode assembly according to claim 9 in at least one of a positive electrode and a negative electrode.

15. A lithium battery, comprising the electrode assembly according to claim 10 in at least one of a positive electrode and a negative electrode.

16. A lithium battery, comprising the electrode assembly according to claim 11 in at least one of a positive electrode and a negative electrode.

17. A lithium battery, comprising the electrode assembly according to claim 12 in at least one of a positive electrode and a negative electrode.

18. A lithium battery, comprising the electrode assembly according to claim 13 in at least one of a positive electrode and a negative electrode.
